(19) United States
(12) Patent Application Publication
(10) Pub. No.: US 2002/0000448 A1
(43) Pub. Date: Jan. 3, 2002

(54) Abrasive particle metering device

(76) Inventors: Frank C. Romeo, Fort Worth, TX (US); Ronald J. Davis, Bedford, TX (US); Paul E. Oehler, Arlington, TX (US)

Correspondence Address: BRACEWELL & PATTERSON, LLP, PO Box 61389, Houston, TX, 77208-1389, US

(21) Appl. No.: 09/872,543

(22) Filed: Jun. 1, 2001

Related U.S. Application Data
(60) Provisional application No. 60/208,635, filed on Jun. 1, 2000.

(51) Int. Cl. G01F 11/00

(52) U.S. Cl. 222/1; 222/185.1; 222/333; 222/412; 222/462

(57) ABSTRACT

An abrasive particle metering device has a supply of fluid abrasive material; a feed tube through which the abrasive material flows; a metering wheel located very near to the feed tube, onto which the feed tube dispenses the abrasive material, and off of which a metered amount of abrasive material is ejected; a funnel to redirect and transport the metered amount of abrasive material; and a motor to drive the metering wheel. The abrasive material is supplied from a storage hopper or some external source. The amount of abrasive material ejected from the metering wheel depends on the rotational rate of the metering wheel. The motor controls the rotational rate of the metering wheel. The flow tube can have a contoured tip to conform to the perimeter of the metering wheel, and the flow tube can be raised or lowered relative to the metering wheel to accommodate various abrasive materials.

This application claims the benefit of U.S. Provisional Application No. 60/208,635 filed Jun. 1, 2000.

### BACKGROUND OF THE INVENTION

1. Field of the Invention

This invention pertains to metering devices and more particularly to metering devices dispensing abrasive material in carefully regulated amounts and rates. The carefully metered abrasive material is delivered to the intake of a high-velocity cutting machine wherein it is accelerated to high velocities to precisely cut an object by erosion.

2. Description of Prior Art

The predominant prior method to deliver a regulated amount of abrasive material for use in a high-velocity erosive cutting device involves a vibratory track in which abrasive material slides down a sloped track under the influence of gravity. The vibration helps to distribute the abrasive material and overcome the frictional force resisting the flow of the abrasive material. The distributed abrasive material streams off the end of the track and is presented to the intake of the high-velocity cutting device.

The rate of vibratory oscillation is generally controlled by electrically driven mechanical oscillators. Those oscillators are sensitive to the voltage fluctuations that commonly occur in industrial applications. Variations in oscillatory rates cause significant variations in the amount of abrasive material dispensed. At present, the cost of the abrasive material is the single highest consumable cost incurred in the cutting operation. Thus, excess vibration can cause excess abrasive material to be dispensed, unnecessarily increasing operational costs. Too little vibration, caused by undervoltage fluctuations, may present too little abrasive material to the cutting device intake, adversely affecting the quality of the cut. Thus, there exists a need to better regulate the amount of abrasive material dispensed in this type of operation.

### SUMMARY OF THE INVENTION

The present invention uses an innovative design to produce an abrasive particle metering device having a supply of fluid abrasive material; a feed tube through which the abrasive material flows; a metering wheel located very near to the feed tube, onto which the feed tube dispenses the abrasive material, and off of which a metered amount of abrasive material is ejected; a funnel to redirect and transport the metered amount of abrasive material; and a motor to drive the metering wheel. The abrasive material is supplied from a storage hopper or some external source. The amount of abrasive material ejected from the metering wheel depends on the rotational rate of the metering wheel. The motor controls the rotational rate of the metering wheel. The flow tube can have a contoured tip to conform to the perimeter of the metering wheel, and the flow tube can be raised or lowered relative to the metering wheel to accommodate various abrasive materials.

### BRIEF DESCRIPTION OF DRAWINGS

FIG. 1 is a section view of an abrasive particle metering device constructed in accordance with this invention.

FIG. 2 is a section view of the abrasive particle metering device of FIG. 1, taken along the line 2-2 of FIG. 1.

FIG. 3 is an elevation view of the metering wheel and drive shaft of the abrasive particle metering device of FIG. 1.

### DETAILED DESCRIPTION OF THE INVENTION

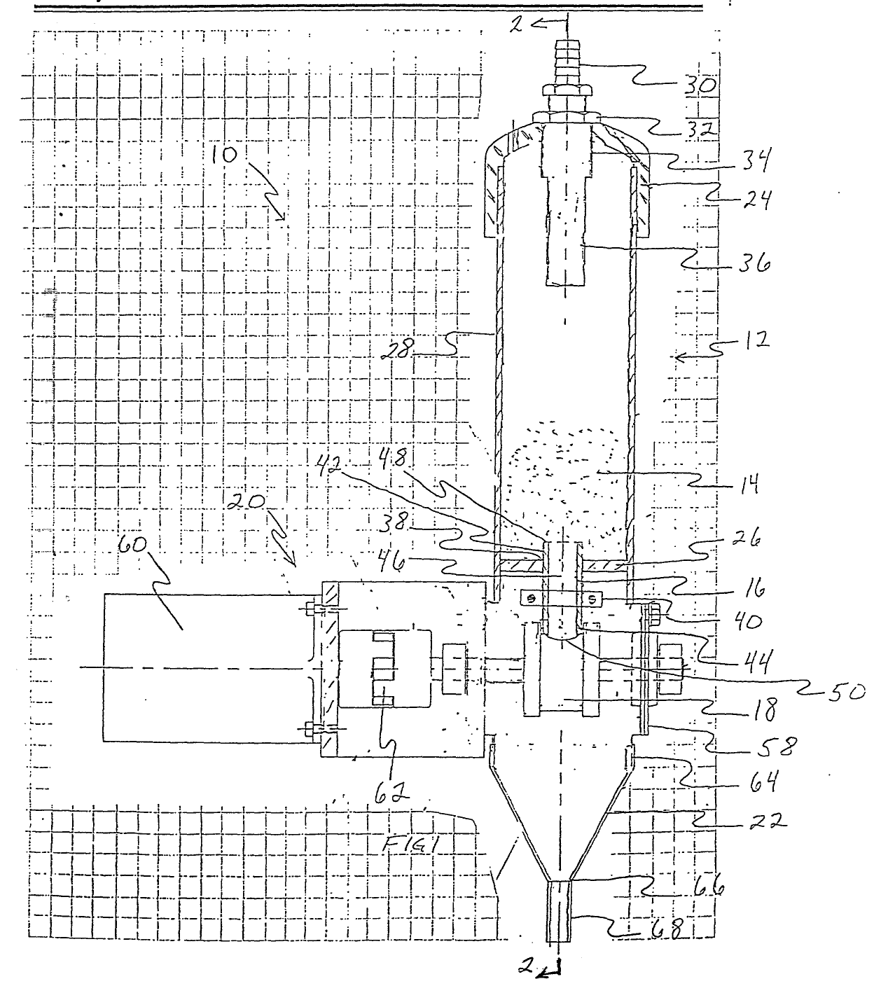

FIG. 1 shows an abrasive particle metering device 10 constructed in accordance with the present invention. The metering device 10 comprises a storage compartment 12 adapted to hold a quantity of abrasive material 14, a feed tube 16, a metering wheel 18, a motor assembly 20, and a funnel 22.

The storage compartment 12 serves to stage a quantity of abrasive material 14. The abrasive material 14 can be an abrasive cutting powder or an abrasive slurry, and may or may not be heated. The abrasive material 14 is sufficiently fluid to flow under the influence of gravity alone or can be assisted by an external source of pressure. If gravity is the main impetus for flow of the abrasive material 14, better results are obtained if the storage compartment 12 is vertically oriented. The abrasive material 14 may be comprised of particles with sizes ranging from 40-mesh to 140-mesh, for example, although the invention is not limited to such particle sizes.

The storage compartment 12 can be pre-filled with abrasive material 14 or can serve as a conduit should one wish to supply abrasive material 14 from an external source (not shown). The storage compartment 12 has a top 24, a bottom 26, and a side wall 28. The side wall 28 may be a completely impervious wall, or it may incorporate a pervious inner wall (not shown) that creates a flow space between the pervious inner wall and the impervious outer wall. The top 24 of the storage compartment 12 is fitted with a connector 30 to permit the abrasive material 14 to be easily transferred into the storage compartment 12. The connector 30 may be, for example, a standard barb-type fitting designed for easy connection and disconnection. The connector 30 is fastened to the top 24 of the storage compartment 12 by conventional means such as a bulkhead fitting 32. The bulkhead fitting 32 has a threaded lower end 34 to which a pipe nipple 36 attaches. The pipe nipple 36 extends a short distance into the interior of the storage compartment 12. The abrasive material 14 enters the storage compartment 12 upon discharge from the pipe nipple 36.

The abrasive material 14 exits the storage compartment 12 by flowing either through and down the flow space (not shown) of the side wall 28 or through an opening 38 in the bottom 26 of the storage compartment 12. In either case, the abrasive material 14 exits the storage compartment 12 through the feed tube 16.

The feed tube 16 is a cylindrical tube that allows for the transfer and delivery of the abrasive material 14 from the storage compartment 12 to the metering wheel 18. The feed tube 16 discharges the abrasive material 14 down onto the metering wheel 18. The feed tube 16 is adjustably mounted to the bottom 26 of the storage compartment 12 by a clamp 40. The clamp 40 can raise or lower the feed tube 16 in response to manual or automated commands. The feed tube 16 has a top end 42 and a bottom end 44, with a conduit 46 through the tube. The top end 42 passes through and seals against the walls bounding the opening 38 in the bottom 26 of the storage compartment 12. The top end 42 extends a short distance into the storage compartment 12 to allow the feed tube 16 to be adjusted to any desired height within a maximum and minimum range of heights. The top end 42 of the feed tube has an upper tip 48. The upper tip 48 defines the exit from the bottom 26 of the storage compartment 12.

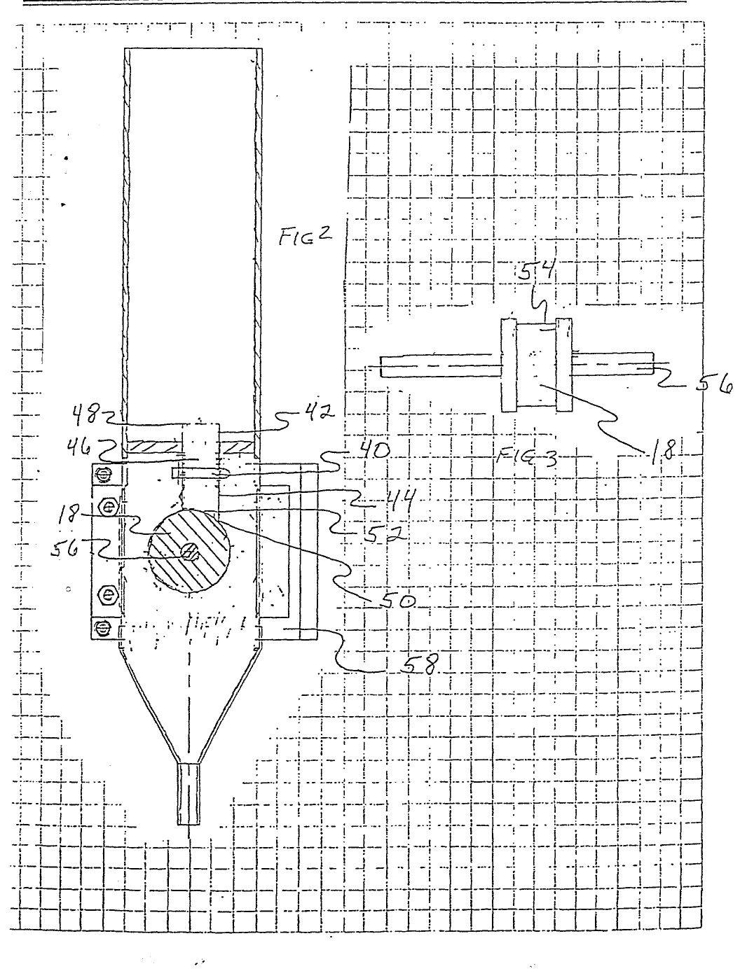

As shown in FIG. 2, the bottom end 44 of the feed tube 16 has a lower tip 50. The lower tip 50 defines a contour 52 conforming to the curvature of the metering wheel 18. The conforming curvature of the contour 52 keeps the gap between the lower tip 50 and the metering wheel 18 equal over the perimeter of the lower tip 50. Thus, as the feed tube 16 is manually or automatically adjusted to a desired distance from the metering wheel 18, the contour 52 maintains the desired gap. In this way, metering device 10 can accommodate various particle sizes of the abrasive material 14.

The metering wheel 18 can comprise a wheel, a screw auger, a conveyer belt, or some other rotational element. For ease of discussion, each of those rotational elements shall be inclusively referred to as the metering wheel 18. The metering wheel 18 serves to dispense the abrasive material 14 in a manner that is linearly dependent on the rotational rate of the metering wheel 18. Thus, a constant amount of abrasive material is dispensed if the rotational rate of the metering wheel is held constant.

FIG. 3 shows the metering wheel 18 as a cylindrical wheel. The metering wheel 18 has an outer surface 54. The abrasive material 14 is dispensed onto the outer surface 54. The outer surface 54 may be smooth or rough. A rough surface tends to improve the cohesion of the abrasive material 14 to the metering wheel 18. The metering wheel 18 is attached to a drive shaft 56 lying along the cylinder axis of the metering wheel 18. The drive shaft 56 is rotatably mounted to a housing 58 so that the drive shaft 56 is perpendicular to the cylinder axis of the feed tube 16. The housing 58 can be an open trough or may completely enclose the metering wheel 18. The housing 58 may be attached to a fixed structure or it may be mounted to a movable carriage.

As shown in FIG. 1, the metering wheel 18 is driven by a motor assembly 20. The motor assembly 20 comprises a motor 60, a coupling 62, and perhaps a gearbox. The motor 60 may be, for example, electric, pneumatic, or hydraulic. Examples of electric motors that may be used include ac motors, servo motors, pulse width modulated motors, and stepper motors. The output of each of those motors can be regulated by controlling one or more inputs to the motor. Controlling the input to the motor is the means by which the rotational rate of the metering wheel 18 is controlled. The input to the motor may be controlled manually, by digital computer, or by an analog circuit. The motor 60 may or may not be connected to a gearbox. Depending on motor characteristics such as power and motor shaft rotational rates, the motor 60 can be geared to produce a desired range of power and rotational rate outputs. The motor shaft, or gearbox output shaft if one is present, connects to the coupling 62. The coupling 62 connects to the drive shaft 56 to drive the metering wheel 18. The motor assembly 20 mounts to the housing 58 so that the coupling 62 aligns with the drive shaft 56.

FIG. 1 shows that the funnel 22 also mounts to the housing 58. The funnel 22 has a wide end 64 and a tapered end 66. The wide end 64 mounts to the housing 58 opposite the feed tube 16. The funnel 22 serves to direct the metered abrasive material 14 to an exit at the tapered end 66. The tapered end 66 connects to a pipe 68. The pipe 68 conveys the metered abrasive material 14 as it appears at the tapered end 68 to a conventional high-pressure jet spray device (not shown). The abrasive material 14 is then entrained by conventional means into the carrier fluid of the jet spray device and discharged at high speed.

The present invention offers many advantages over the prior art. The amount of abrasive material 14 metered out can be manually or automatically regulated to control cutting parameters such as draft angle, washout, speed of cut, and sharpness of comers. Metering device 10 improves cut quality because the metered amount of abrasive material dispensed is highly controllable and the resolution of feed rate adjustment is fine. Expensive waste from excess abrasive material being consumed is eliminated. The rotational inertia of the rotational element helps maintain accurate metering that is less sensitive to voltage fluctuations than conventional methods.

While the invention has been particularly shown and described with reference to a preferred and alternative embodiments, it will be understood by those skilled in the art that various changes in form and detail may be made therein without departing from the spirit and scope of the invention.

We claim:

1. An abrasive particle metering device comprising:
abrasive material;
a feed tube through which the abrasive material flows and is discharged at one end of the feed tube;
a metering wheel located near the feed tube discharge end, onto which the feed tube dispenses the abrasive material, and off of which a metered amount of abrasive material is ejected; and
a motor connecting to and driving the metering wheel.

2. The metering device of claim 1 wherein the abrasive material is a powder.

3. The metering device of claim 1 wherein the abrasive material is a slurry.

4. The metering device of claim 1 wherein the metering wheel has a perimeter and the feed tube discharge end has a contoured tip in close proximity with and conforming to the perimeter of the metering wheel.

5. The metering device of claim 1 wherein the feed tube can be adjusted to vary the distance between the discharge end of the feed tube and the metering wheel.

6. The metering device of claim 1 wherein the metering wheel is a wheel.

7. The metering device of claim 1 wherein the metering wheel is a screw auger.

8. The metering device of claim 1 wherein the metering wheel is a conveyer belt.

9. The metering device of claim 1 wherein the motor is a motor assembly further comprising a gearbox and a coupling.

10. An abrasive particle metering device comprising:
a storage hopper;
abrasive material within the storage hopper;
a feed tube attached to the hopper and having a discharge tip through which the abrasive material exits the hopper;
a metering wheel located below the feed tube discharge tip, onto which the feed tube dispenses the abrasive material, and off of which a metered amount of abrasive material is ejected;
a funnel to redirect and transport the metered amount of abrasive material; and
a motor to drive the metering wheel.

11. The metering device of claim 10 wherein the abrasive material is a powder.

12. The metering device of claim 10 wherein the abrasive material is a slurry.

13. The metering device of claim 10 wherein the metering wheel has a perimeter and the feed tube discharge tip is very near the perimeter of the metering wheel and contoured to conform to the perimeter of the metering wheel.

14. The metering device of claim 10 wherein the feed tube can be adjusted to vary the distance between the discharge tip and the perimeter of the metering wheel.

15. The metering device of claim 10 wherein the metering wheel is a wheel.

16. The metering device of claim 10 wherein the metering wheel is a screw auger.

17. The metering device of claim 10 wherein the metering wheel is a conveyer belt.

18. A method of dispensing a carefully metered amount of abrasive material comprising the steps of:
delivering abrasive material to a feed tube;
passing the abrasive material through the feed tube onto a spinning rotational element;
ejecting the abrasive material from the rotational element; and
controlling the rotational rate of the rotational element to meter the amount and rate of ejection of the abrasive material.

19. The method of claim 18 further comprising the step of adjusting the distance between the feed tube and the rotational element to accommodate various abrasive materials.

20. The method of claim 18 further comprising the step of funneling the metered abrasive material to redirect and transport the metered abrasive material.
